(19) United States
(12) Patent Application Publication
(10) Pub. No.: US 2025/0379536 A1
(43) Pub. Date: Dec. 11, 2025

(54) METHOD OF OPERATING AN INVERTER, INVERTER, AND DRIVE UNIT

(71) Applicant: Valeo eAutomotive Germany GmbH, Erlangen (DE)

(72) Inventor: Marek LEWANDOWSKI, Erlangen (DE)

(73) Assignee: Valeo eAutomotive Germany GmbH, Erlangen (DE)

(21) Appl. No.: 19/229,507

(22) Filed: Jun. 5, 2025

(30) Foreign Application Priority Data
Jun. 5, 2024 (DE) 10 2024 115 718.6

(51) Int. Cl. H02P 27/08; H02P 6/08; H02P 6/12

(52) U.S. Cl. CPC H02P 27/08; H02P 6/085; H02P 6/12

(57) ABSTRACT

A method of operating an inverter, and inverter, and a drive unit. The inverter is adapted for outputting phase currents to an electric motor and includes several power switches controlled by a control device of the inverter. The power switches of the inverter are controlled according to a standard inverter control strategy based on a torque request signal such that an output power of the inverter being determined by output signals of the inverter generally corresponds to the torque request signal. The unfiltered torque request signal is compared with a filtered torque request signal for determining a thermal stress factor of the inverter. The filtered torque request signal includes trailing edges having a reduced slew rate compared to trailing edges of the unfiltered torque request signal. It is changed to an adapted inverter control strategy if the thermal stress factor exceeds a first predetermined threshold.

The invention relates to a method of operating an inverter, an inverter, and a drive unit.

Inverters for operating electric motors are commonly operated such that the focus lies on highly efficient modes of operation. This means that as soon as the AC current can be reduced, it will be reduced to achieve consumption optimization. This is good from the point of view of efficiency, but leads to rapid temperature changes in the power stage and, thus, to a mechanical stress aging the inverter.

Accordingly, the lifetimes of inverters are limited. Notably, this ramping temperature change is different from the common temperature aging effect which in effect depends on the average temperature of the inverter.

In more detail, for the special configuration of repetitive peak loads applied to inverters, for example due to strong acceleration requests from a driver, these peak loads tend to stress the power stage with thermal cycling. Thereby, a lifetime penalty is incurred such that the usability of the inverter is limited.

In some scenarios, the peak power is limited not by an absolute inverter temperature (average temperature of the inverter) but by the depth of the thermal cycles stressing the power stage structure. Put differently, while usually the absolute temperature limits the peak power achievable for the inverter, as a result of repetitive peak loads, the strong thermal cycles implied thereby may limit the achievable peak power, though the inverter has not yet been operated for long or did yet only operate at moderate average temperatures. Hence, in some operating scenarios, the thermal cycles may be so often (high repetition frequency), so large (high amplitudes), and so sudden (high slew rates) that the power which the inverter can provide is reduced.

Accordingly, there is need for a method, an inverter, and a drive unit enabling the inverter to be used at specialized operating scenarios while the lifetime of the inverter is elongated as compared to known approaches.

The objective technical problem to be solved may be considered to consist in overcoming or at least reducing the disadvantages according to the prior art by providing a method, an inverter, and a drive unit enabling the inverter also to be reliably and continuously being usable at repetitive peak loads while simultaneously providing lifetime improvements.

The problem is solved by the subject matter of the independent claims. Preferred embodiments are indicated within the dependent claims and the following description, each of which, individually or in combination, may represent aspects of the disclosure. Some specifics of the present disclosure are described with regard to devices and others with regard to corresponding methods. However, the advantages and preferred embodiments described with regard to the indicated devices are correspondingly to be transferred to the according methods and vice versa.

According to an aspect, a method of operating an inverter adapted for outputting phase currents to an electric motor is provided. The inverter comprises several power switches controlled by a control device of the inverter. The method comprises at least the steps of:
The power switches of the inverter are controlled according to a standard inverter control strategy based on a torque request signal such that an output power of the inverter being determined by output signals of the inverter generally corresponds to the torque request signal.
An unfiltered torque request signal is compared with a filtered torque request signal for determining a thermal stress factor of the inverter. The filtered torque request signal comprises trailing edges having a reduced slew rate compared to trailing edges of the unfiltered torque request signal.
The control is changed to an adapted inverter control strategy for controlling the power switches of the inverter if the thermal stress factor exceeds a first predetermined threshold. According to the adapted inverter control strategy, the inverter is controlled to generate waste heat after the torque request signal has dropped.
The control is changed back to the standard inverter control strategy for controlling the power switches of the inverter if the thermal stress factor falls below a second predetermined threshold.

The invention is based on the finding that the slew rate of the trailing edge of the torque request signal can be modified such that waste heat is generated. Due to the waste heat, the temperature of the inverter does not fall as fast as possible (at lower slew rates) as this is the case when applying the common standard inverter control strategy which aims at minimizing power losses. Put differently, while in case of the rising edges maximum slew rates are applied to provide fast responses when high torque loads are requested, the slew rates of the trailing edges can be effectively lower (reduced) as compared to the maximum slew rate possible in view of the trailing edges for the price of additional power consumption. As to the adaption of the slew rate of the trailing edges, the thermal stress induced in the inverter, even in special operating conditions, such as repetitive high torque requests, can be reduced. As a consequence, the temperature variations of the inverter are at least in part effectively dampened such that the lifetime of the inverter is elongated.

Moreover, if repetitive torque request signals occur in short intervals, the adapted inverter control strategy also assists in weakening the effect of the rising edges. This is because the slew rate of the trailing edges, in terms of absolute values, is smaller than the slew rate of the trailing edges of the standard inverter control strategy. Since the cooling devices for removing the heat from the inverter only have a predetermined constant cooling power, the temperature of the inverter may not yet have fallen to the lowest temperature possible, as the temperature fall is slowed down/delayed in view of the smaller slew rate of the trailing edges of the adapted inverter control strategy. Accordingly, if the next torque request signal demanding a peak power occurs, the temperature rise may not be as high as for the case of the standard inverter control strategy since the inverter potentially did not yet cool down to the lowest temperature possible. Therefore, as a consequence of the adapted inverter control strategy, the absolute temperature rise (difference between the temperature before the rising edge and subsequent to the rising edge) induced by the next rising edge of the torque request signal, may be smaller according to the adapted inverter control strategy. Hence, the thermal stress implied by the repetitive torque request signals is reduced also in this additional indirect aspect.

As the thermal cycling can be dampened according to the above described method, the thermal stresses induced by repetitive high peak loads can be reduced. This enables to balance the peak load induced thermal stresses to the (common) thermal stresses which are caused by the average (absolute) temperature of the inverter. In effect, the thermal stresses induced by the different aspects can be balanced with each other to widely correspond to each other. Thereby, no single one of the thermal stress mechanisms is superior as compared to the other one. As a result, the lifetime of the inverter is optimized from a thermal stress point of view.

According to another aspect, an inverter adapted for outputting phase currents to an electric motor coupled thereto is provided. The inverter comprises several power switches and a control device. The power switches of the inverter are controllable by the control device such that output signals are output to the electric motor for establishing phase currents therein. The control device is configured to:
control the power switches of the inverter according to a standard inverter control strategy based on a torque request signal received by the inverter such that an output power of the inverter being determined by output signals of the inverter generally corresponds to the torque request signal,
determine a thermal stress factor of the inverter based on a comparison between the unfiltered torque request signal and a filtered torque request signal. The filtered torque request signal comprises trailing edges having a reduced slew rate compared to trailing edges of the unfiltered torque request signal.
change to an adapted inverter control strategy if the thermal stress factor exceeds a first predetermined threshold. According to the adapted inverter control strategy, the inverter is controlled to generate waste heat after the torque request signal has dropped.
change back to the standard inverter control strategy if the thermal stress factor falls below a second predetermined threshold.

The advantages achieved in view of the hereinbefore explained method are readily achieved in view of the drive unit as well.

According to yet another aspect, a drive unit is provided. The drive unit comprises an inverter as disclosed hereinbefore and an electric motor coupled to outputs of the inverter for receiving output signals of the inverter.

The advantages achieved in view of the hereinbefore explained method are readily achieved in view of the drive unit as well.

Optionally, the power switches may be transistors, such as MOSFETs or bipolar junction transistors.

In some embodiments, the standard inverter control strategy may be such that the power switches are controlled by the control device according to applying maximum slew rates (absolute values) in view of the rising edges as well as the trailing edges of the torque request signal. Put differently, according to the standard inverter control strategy, variations of the torque request signal are responded to as fast as possible. Accordingly, the electric power losses induced by the standard inverter control strategy are minimized upon operating the inverter.

Preferably, the thermal stress factor is not required to represent a true thermal load applied to the inverter by a specific control strategy. Rather, the thermal stress factor represents a qualitative value which is usable to assist in determining whether or not a specific control strategy is to be applied for controlling the inverter. Put differently, based on the thermal stress factor, it may be determined as to whether a single one of the thermal stress mechanisms is superior compared to the other one. If the thermal stress factor indicates such a configuration, the control strategy is to be adapted in order to optimize the lifetime of the inverter. In other words, the thermal stress factor is an auxiliary value for the determination procedure regarding the control strategy to be applied.

In some embodiments, the thermal stress factor is determined based on a loss level estimator being part of the control device. The loss level estimator is configured to determine how much electric losses are generated in the power stage of the inverter depending on the respective unfiltered/filtered torque request signal. As the temperature of the inverter depends on the electric losses, thereby the loss level estimator provides an indication for the expected evolution of the temperature of the inverter in dependence of the specific inverter control strategy.

Optionally, at least one filter is applied to achieve the filtered torque request signal as compared to the unfiltered torque request signal. By means of the filter, the slew rate of the trailing edges of the filtered torque request signal is adapted as compared to the slew rate of the trailing edges of the unfiltered torque request signal. In effect, based on the filter, the slew rate of the trailing edges of the filtered torque request signal has a smaller absolute value as compared to the slew rate of the trailing edges of the unfiltered torque request signal.

In some embodiments, the first predetermined threshold and/or the second predetermined threshold may be constant.

In an alternative, the first predetermined threshold and/or the second predetermined threshold may also be variable. For example, the first predetermined threshold and/or the second predetermined threshold may be adapted in view of several parameters and operating conditions when operating the inverter. In some exemplary scenarios, the first predetermined threshold and/or the second predetermined threshold may depend on the average temperature of the inverter, a total operating time of the inverter, peak loads which are requested according to the unfiltered//filtered torque requests signals and others.

Optionally, a fast rise/slow trail filter is applied to the torque request signal by the control device for achieving a filtered torque request signal. This filter enables the slew rate of the rising edge to be high (high absolute values) while the slew rate of the trailing edges is effectively reduced (smaller absolute values) as compared to the unfiltered torque request signal. In an exemplary scenario, the fast rise/slow trail filter could be mathematically described by:

$${y}_{n + 1} = \{ \begin{matrix}{x}_{n} , & if {x}_{n} \geq {y}_{n} \\ {y}_{n} \cdot k , & k < 1 otherwise\end{matrix}$$

In effect, in view of the trailing edge the torque request signal is multiplied with factor k being smaller than 1 which guarantees that the absolute value of the slew rate of the trailing edge of the filtered torque request signal is smaller than the slew rate of the trailing edge of the unfiltered torque request signal. Other realizations are possible of course as well, such as an electronic control procedure including a comparator for assessing both configurations, i.e. unfiltered/filtered torque request signals.

In some embodiments, the fast rise/slow trail filter may be part of the control device of the inverter.

Preferably, for the adapted inverter control strategy, a commutation angle between the d/q output currents output by the inverter is adjusted to be non-orthogonal. In the auxiliary description picture for the output currents of the inverter to drive the electric motor, the three-phase current configuration is describable using the two-dimensional d/q current representation. In the d/q current representation, the commutation angle between the d output current and the q output current is usually 90°, i.e. the d current and the q current are aligned orthogonal to each other. Thereby, the electric power losses for operating the inverter according to the standard inverter control strategy are minimized.

The invention makes use of the finding that for the trailing edges the commutation angle between the d current and the q current can be adapted such that the currents are not aligned orthogonal to each other (i.e. adapted inverter control strategy). As a consequence, to achieve similar output torques higher d and q output currents are required. This leads to the effect that the drop (decay) of the output currents is slowed down (smaller absolute values of the slew rate) as compared to the configuration of using d and q output currents which are aligned orthogonal to each other (i.e. standard inverter control strategy) and assuming similar output torques. Accordingly, the adapted inverter control strategy is adapted such that the fraction of reactive-power is increased as compared to the standard inverter control strategy. Thus, the torque is removed while the AC current keeps flowing. This leads to a slower temperature drop of the inverter at the cost of increased electric power losses such that the thermal stress of the peak load configuration is not as steep (sudden) as compared to the standard inverter control strategy.

In some embodiments, the thermal stress factor of the inverter exceeds the first predetermined threshold if for a predetermined first number of torque request signals within a predetermined first time period, electric losses according to unfiltered torque request signal trailing edge undercut (or exceed; depending on the sign definition) losses according to filtered torque request signal trailing edges by a predetermined first difference threshold. This means that the losses are considered simultaneously for both the unfiltered torque request signal and the filtered torque request signal. If the difference between the losses exceeds the predetermined first different threshold (n times within the first time period), this fact is used as an indication that the inverter control strategy is to be adapted for reducing the thermal peak loads implied by the operating conditions to the inverter. Therefore, a robust approach is provided for assessing as to whether a change to the adapted inverter control strategy is required. For example, based on the predetermined first number vs. the predetermined first time period being necessary for triggering the change of the control strategy, it can be avoided that spontaneous fluctuations immediately cause the change to be executed. Moreover, the predetermined first difference threshold also assists in identifying specific configurations according to which a change of the control strategy is indeed required and beneficial.

Although the standard inverter control strategy generally provides minimal losses, the difference between the losses of the respective trailing edges does not necessarily exceed the first difference threshold. In particular, the first difference threshold is usually not exceeded if the repetition frequency and/or the amplitude of the torque request signal are not high enough. In essence, in this configuration, the differences in losses caused by the different inverter control strategies do not necessarily exceed the filter constant of the fast rise/slow trail filter. Put differently, the torque request signal does then not comprise trailing edges which are deep (high amplitudes), sudden (high slew rates) and often (high frequencies) enough for the adapted inverter control strategy to be activated.

In some embodiments, the thermal stress factor falls below the second predetermined threshold if for a predetermined second number of torque request signals within a predetermined second time period, electric losses according to the unfiltered torque request signal trailing edge do not undercut (or do not exceed; depending on the sign definition) losses according to the filtered torque request signal trailing edges by a predetermined second difference threshold. Accordingly, in parallel to changing the inverter control strategy to the adapted inverter control strategy, the assessment of the electric power losses caused by the different control strategies is executed further. As a consequence it is assessed, whether the inverter control strategy can be switched back to the standard inverter control strategy to achieve a configuration in which minimal electric losses are caused.

Preferably, the first predetermined threshold and the second predetermined threshold are different from each other. Hence, a hysteresis can be provided such that a fluctuating decision behavior is avoided.

Optionally, any one of the predetermined first number, the predetermined second number, the predetermined first time period, the predetermined second time period, the predetermined first difference threshold, and the predetermined second difference threshold may be variable. Therefore, the decision procedure can be adapted for each specific drive unit including a specific inverter and a specific electric motor.

In some embodiments, the control device is configured to control the power switches of the inverter according to the unfiltered torque request signal when applying the standard inverter control strategy. Accordingly, the inverter may be operated at conditions at which minimum electrical losses are caused.

Preferably, the control device is configured to adjust a commutation angle between the d/q output currents output by the inverter to be orthogonal and to be non-orthogonal. Hence, an efficient way to cause additional electric losses is achieved such that the slew rate of the trailing edges of the torque request signal may be effectively influenced.

All features and embodiments disclosed with respect to any aspect of the present disclosure are combinable alone or in (sub-) combination with any one of the remaining aspects of the present disclosure including each of the preferred embodiments thereof, provided the resulting combination of features is reasonable to a person skilled in the art.

The forgoing aspects and further advantages of the claimed subject matter will become more readily appreciated as the same become better understood by reference to the following detailed description when taken in conjunction with the accompanying drawings. In the drawings,

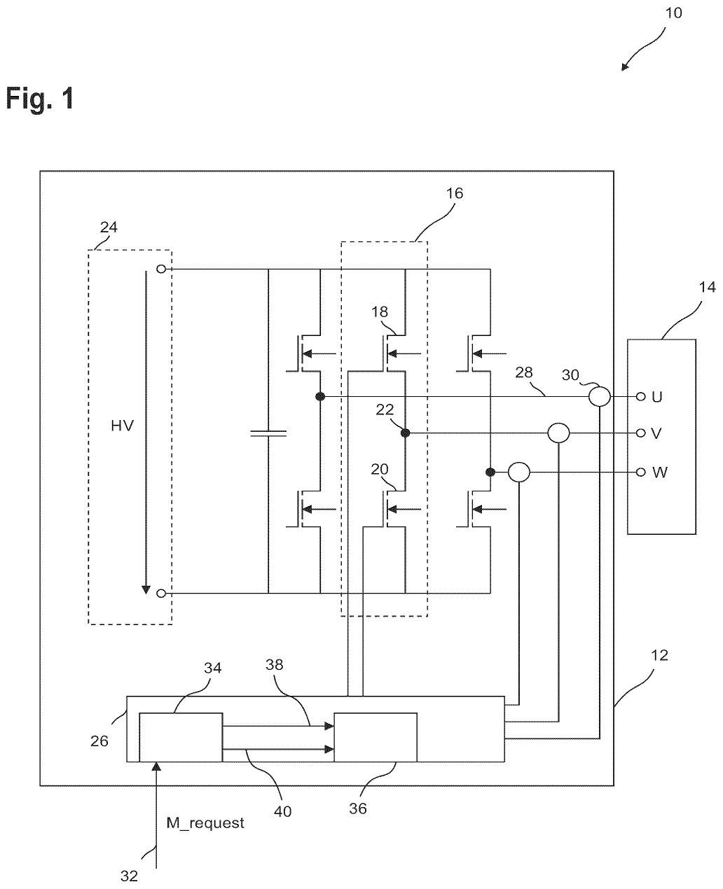

FIG. 1 is a schematic drawing of drive unit according to an embodiment,

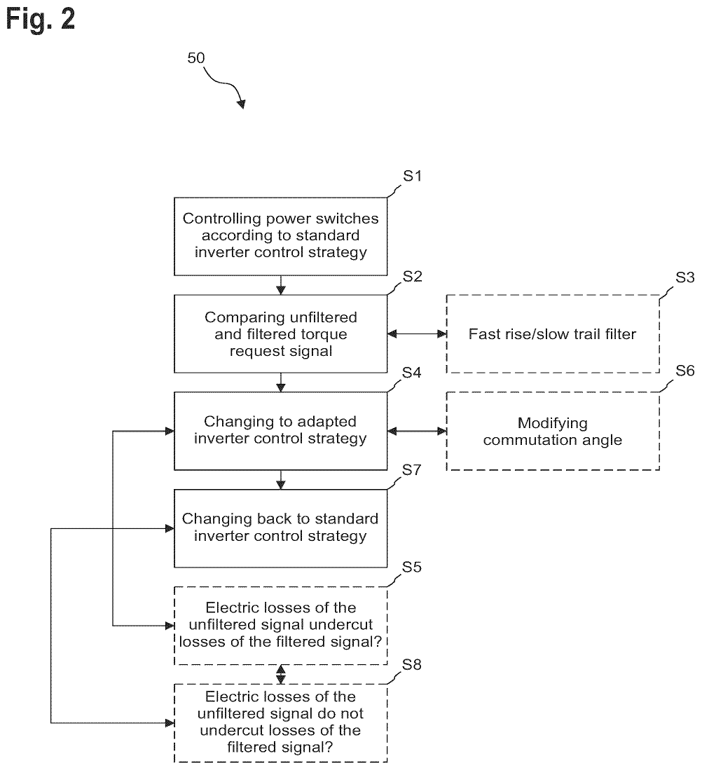

FIG. 2 is a schematic drawing of a method of operating an inverter according to an embodiment, and

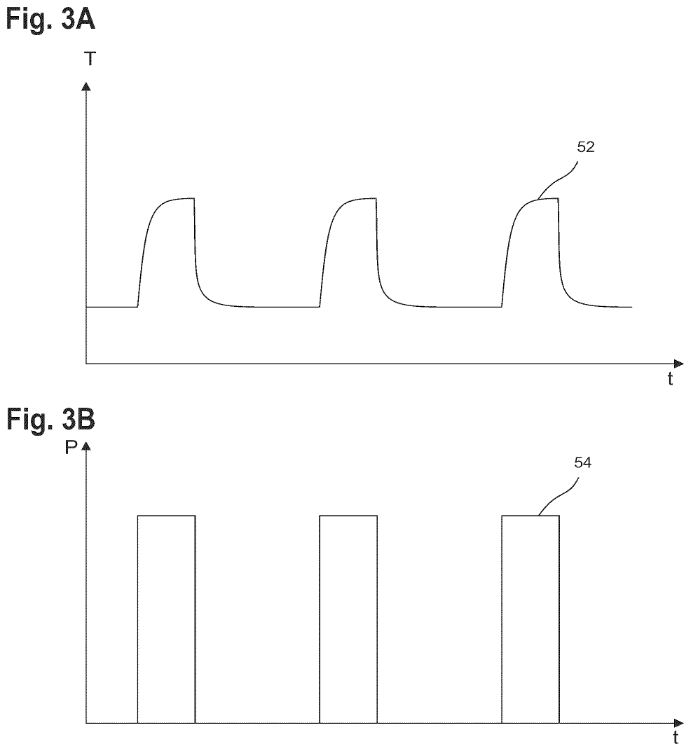

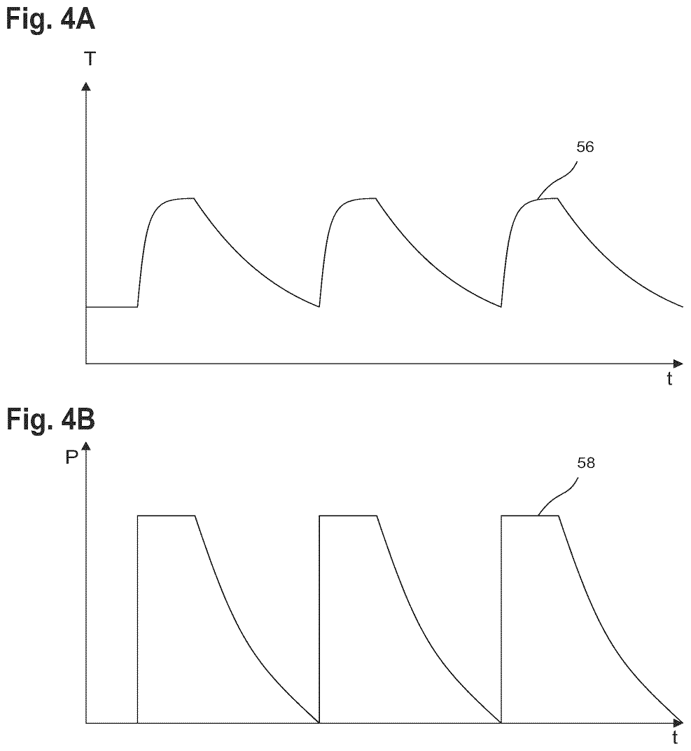

FIGS. 3A, 3B and 4A, and 4B are schematic drawings of temperature and power loss evolutions within the course of the method of FIG. 2.

All of the features disclosed hereinafter with respect to the example embodiments and/or the accompanying figures can alone or in any sub-combination be combined with features of the aspects of the present disclosure including features of preferred embodiments thereof, provided the resulting feature combination is reasonable to a person skilled in the art.

FIG. 1 is a schematic drawing of drive unit 10 including an inverter 12 and an electric motor 14 according to an embodiment. Here, the electric motor 14 is a current-excited synchronous machine.

According to this embodiment, the inverter 12 comprises a B6 bridge with three half bridges 16.

Each half-bridge 16 comprises a first power switch 18 acting as a high-side switch, and a second power switch 20 acting as a low-side switch. Here, both power switches 18, 20 are transistors, e.g. n-channel MOSFETs. Between the first power switch 18 and the second power switch 20, each half-bridge 16 comprises a center tap 22 for providing respective phase voltages U, V, W for the electric motor 14, through each of which a phase current is driven or set (for example, based on the machine parameters of the electric motor 14).

The three half-bridges 16 apply three corresponding phase voltages, U, V and W, to the electric motor 14. However, other topologies, for example a six-phase electric motor 14, are also possible, which then require corresponding modifications to the inverter 12.

The respective half bridges 16 are coupled via lines to a current source 24, for example a high-voltage storage unit, whose electrical energy is converted into kinetic energy by means of the electric motor 14. The electric motor 14 can be used to drive a vehicle, for example. In this case, the current source 24 is configured to provide a high-voltage HV of 800 V. Of course, other current sources 24 are possible, as well.

The inverter 12 comprises a control device 26 which is configured to control the switching states of the power switches 18, 20. Depending on the switching positions of the power switches 18, 20, corresponding commutation cells are formed in the inverter 12 when the high-voltage voltage is applied.

For reasons of clarity, the respective connection of the control device 26 is only shown continuously to the power switches 18, 20 of the first half bridge 16. The other connections between the control device 26 and the remaining half bridges 16 are omitted.

Put differently, the control device 26 is configured to at least indirectly provide corresponding (digital) switching signals for the power switches 18, 20, optionally through gate driver circuits.

The inverter 10 comprises output busbars 28, which are coupled on the one hand to the center taps 22 of the half bridges 16, and on the other hand to the electric motor 14. In this respect, three output busbars 28 are displayed in the embodiment shown. With the aid of the output busbars 28, the electrical power is output from the inverter 12 to the electric motor 14.

Phase current sensors 30 are provided, which are arranged at the output busbars 28. The phase current sensors 30 detect the respective phase currents occurring due to the output phase voltages U, V and W, i.e. the actual values of the phase currents, and transmit the corresponding values to the control device 26. Based on the detected phase currents, the required states of the power switches 18, 20 can be determined by the control device 26 in order to serve a specific torque request signal 32 M_request received by the control device 26 from an external source.

Usually, the control device 26 comprises a current controller and a pulse width modulator in order to determine the required changes to the switching states of the power switches 18, 20 depending also on the acquired measurement values of the detected phase currents for serving the specific torque request signal 32 M_request. Thereby, it is ensured that the actual phase current is matched to the target phase current which depends on the specific torque request signal 32. In some examples, the torque request signal 32 may depend on a pedal position of the driver.

Here, the control device 26 also comprises a fast rise/slow trail filter 34 and a loss level estimator 36.

The fast rise/slow trail filter 34 is configured such that the specific torque request signal 32 is output in an unfiltered manner as unfiltered torque request signal 38 and, in addition, also as a filtered torque request signal 40. In this regard, FIGS. 3A, 3B and 4A, and 4B are schematic drawings of temperature and power loss evolutions within the course of the method of FIG. 2.

Specifically, FIG. 3A shows the temperature evolution 52 of the inverter 12 as a consequence of applying a standard inverter control strategy according to the unfiltered torque request signal 38 by the control device 26. It is shown that according to the standard inverter control strategy, the temperature evolution 52 shows rising edges and trailing edges having respective high slew rates. Simultaneously, the power loss evolution 54 according to the standard inverter control strategy comprises a rectangular profile (see FIG. 3B). The shapes of the temperature evolution 52 and the power loss evolution 54 are consequences of controlling the inverter 12 such that the unfiltered torque request signal 40 is served with quickest modifications of the output torque provided by the electric motor 14 as possible. This means, if the unfiltered torque request signal 40 requests a rise of the output torque, the inverter 12 is controlled by the control device 26 such that the output torque provided by the electric motor 14 is ramped up as fast as possible (with the highest absolute value of the slew rate possible). Also, when the unfiltered torque request signal 40 requests a drop of the output torque, the control device 26 controls the inverter 12 such that the torque provided by the electric motor 14 is reduced as fast as possible (with the highest absolute value of the slew rate possible). Thereby, the rectangular shape of the power loss evolution 54 is achieved. Hence, the inverter 12 and the electric motor 14 are operated according to the standard inverter control strategy such that minimal electric losses are caused.

In contrast, for the adapted inverter control strategy, the control device 26 makes use of the filtered torque request signal 40. In comparison to the temperature evolution 52 of the standard inverter control strategy, the temperature evolution 56 according to the adapted inverter control strategy also comprises a sharp rising edge (see FIG. 4A). Likewise, the rising edge of the power loss evolution 58 (see FIG. 4B) also comprises an L-shape. That is the consequence of an increase of the torque request of the filtered torque request signal 40 being immediately served similar to the standard inverter control strategy by the control device 26. In other words, if a rise of the output torque is requested, the control device 26 controls the inverter 12 such that the output torque provided by the electric motor 14 increases as fast as possible.

However, this is different for the trailing edge if the filtered torque request signal 40 indicates that a drop (reduction) of the output torque of the electric motor 14 is requested. In this case, the control device 26 modifies the control of the inverter 12 as compared to the case of the standard inverter control strategy such that the temperature evolution 56 shows a slower fall (decay) of the temperature of the inverter 12. Likewise, the power loss evolution 58 also shows that the trailing edge is not sharp but that the power losses slowly run out if the output power provided by the electric motor 14 is reduced.

In this regard, the fast rise/slow trail filter 34 modifies the specific torque request signal 32 such that the trailing edge of the torque request is adapted so as to dampen the temperature evolution and the power loss trailing edges. For example, this may be achieved by the control device 26 adapting the commutation angle between the different phase currents d and q which may be considered a two-dimensional representation of the three different phase currents U, V, W output by the inverter 12.

The loss level estimator 36 of the control device 26 is used to determine whether or not the inverter control strategy is changed from the standard inverter control strategy to the adapted inverter control strategy and vice versa. In particular, the loss level estimator 36 evaluates the power losses caused by the different control strategies according to the unfiltered torque request signal 38 and the filtered torque request signal 40. In particular, the loss level estimator 36 compares the unfiltered torque request signal 38 to the filtered torque request signal 40.

FIG. 2 is a schematic drawing of a method 50 of operating an inverter 12 according to an embodiment. Optional steps are shown in dashed lines.

In step S1, the power switches 18, 20 of the inverter 12 are controlled by the control device 26 according to a standard inverter control strategy based on a torque request signal 32 such that an output power of the inverter 12 being determined by output signals U, V, W of the inverter 12 generally corresponds to the torque request signal 32. As mentioned earlier, the standard inverter control strategy is such that the power losses caused thereby are minimized, compare the power loss evolution 54 shown in FIG. 3B. Put differently, rises and drops of the torque request are served as fast as possible based on correspondingly controlling the power switches 18, 20 of the inverter 12.

In subsequent step S2, the control device 26 compares the unfiltered torque request signal 38 with a filtered torque request signal 40 for determining a thermal stress factor of the inverter 12. The filtered torque request signal 40 comprises trailing edges having a reduced slew rate compared to trailing edges of the unfiltered torque request signal 38. The trailing edges of the respective torque request signals 38, 40 propagate into respective power loss evolutions 54, 58, compare FIGS. 3B and 4B.

Step S2 can be modified by optional step S3 in that the filtered torque request signal 40 is provided by the fast rise/slow trail filter 34.

Based on the comparison carried out by the control device 26 in step S2, the control of the power switches 18, 20 can be changed to an adapted inverter control strategy by the control device 26 if the thermal stress factor exceeds a first predetermined threshold, see step S4. According to the adapted inverter control strategy, the inverter 12 is controlled to generate waste heat after the torque request signal has dropped. In this regard, the waste heat can be identified by the trailing edge of the temperature evolution 56 according to the adapted inverter control strategy shown in FIG. 4A. having a lower slew rate as compared to the temperature evolution 52.

The thermal stress factor may be determined by the control device 26 by making use of the loss level estimator 36. The loss level estimator 36 is configured to compare the power losses caused by a control strategy according to the unfiltered torque request signal 38 and by the adapted control strategy according to the filtered torque request signal 40. In particular, the loss level estimator 36 evaluates whether for a predetermined first number of torque request signals 32 within a predetermined first time period, electric losses according to unfiltered torque request signal 38 trailing edges undercut losses according to filtered torque request signal 40 trailing edges by a predetermined first difference threshold. If this is the case, the thermal stress factor exceeds the first predetermined threshold (see optional step S5) and a change of the standard inverter control strategy to the adapted inverter control strategy is initiated by the control device 26.

Practically, the modification of the trailing edge and the generation of additional waste heat can the achieved by the control device 26 by adapting the commutation angle between the d- and q-currents (see optional step S6) which may be considered a two dimensional representation of the actual output currents U, V, and W. While for the standard inverter control strategy, the commutation angle is 90° so that the d-current and the q-current are oriented orthogonal to each other, in case of the adapted inverter control strategy the commutation angle may be different from 90°, in particular, for the time period of the trailing edge of the filtered torque request signal 40.

Method 50 then continues with step S7, according to which the control device 26 changes the control strategy back to the standard inverter control strategy if the thermal stress factor falls below a second predetermined threshold.

In this regard, step S7 may comprise the optional step S8, according to which again the loss level estimator 36 is used for evaluating the electric losses caused by the trailing edges of the unfiltered torque request signal 38 as compared to the electric losses caused by the trailing edges of the filtered torque request signal 40. If, subsequent to step S4, for a predetermined second number of torque request signals 32 within a predetermined second time period, electric losses according to the unfiltered torque request signal 38 trailing edge do not undercut losses according to the filtered torque request signal 40 trailing edges by a predetermined second difference threshold, the thermal stress factor falls below the second predetermined threshold. Then, the control device 26 modifies the inverter control strategy back to the standard inverter control strategy to achieve a configuration in which minimal electrical losses are caused.

Optionally, the first different threshold is different from the second difference threshold such that a hysteresis is provided.

Optionally, the first predetermined threshold and the second predetermined threshold are different from each other such that a hysteresis is provided, as well.

In effect, strong temperature drops of the inverter 12 can be dampened by the adapted inverter control strategy for the specific configuration of repetitive high torque requests. Therefore, the thermal stress-induced aging effects can be reduced such that the lifetime of the inverter 12 and thereby the drive unit 10 are elongated.

For the purposes of the present disclosure, the phrase “at least one of A, B, and C”, for example, means (A), (B), (C), (A and B), (A and C), (B and C), or (A, B, and C), including all further possible permutations when greater than three elements are listed. In other words, the term “at least one of A and B” generally means “A and/or B”, namely “A” alone, “B” alone or “A and B”.

1. A method of operating an inverter adapted for outputting phase currents to an electric motor, wherein the inverter comprises several power switches controlled by a control device of the inverter, wherein the method comprises at least the steps of:
Controlling the power switches of the inverter according to a standard inverter control strategy based on a torque request signal such that an output power of the inverter being determined by output signals of the inverter generally corresponds to the torque request signal,
Comparing an unfiltered torque request signal with a filtered torque request signal for determining a thermal stress factor of the inverter, wherein the filtered torque request signal comprises trailing edges having a reduced slew rate compared to trailing edges of the unfiltered torque request signal,
Changing to an adapted inverter control strategy if the thermal stress factor exceeds a first predetermined threshold, wherein, according to the adapted inverter control strategy, the inverter is controlled to generate waste heat after the torque request signal has dropped, and
Changing back to the standard inverter control strategy if the thermal stress factor falls below a second predetermined threshold.

2. The method of claim 1, wherein a fast rise/slow trail filter is applied to the torque request signal by the control device for achieving a filtered torque request signal.

3. The method of claim 1, wherein the standard inverter control strategy is such that electric losses are minimized upon operating the inverter.

4. The method of claim 1, wherein for the adapted inverter control strategy a commutation angle between the d/q output currents output by the inverter is adjusted to be non-orthogonal.

5. The method of claim 1, wherein the thermal stress factor of the inverter exceeds the first predetermined threshold if for a predetermined first number of torque request signals within a predetermined first time period, electric losses according to unfiltered torque request signal trailing edge undercut losses according to filtered torque request signal trailing edges by a predetermined first difference threshold.

6. The method of claim 5, wherein the thermal stress factor falls below the second predetermined threshold if for a predetermined second number of torque request signals within a predetermined second time period, electric losses according to the unfiltered torque request signal trailing edge do not undercut losses according to the filtered torque request signal trailing edges by a predetermined second difference threshold.

7. The method of claim 1, wherein the first predetermined threshold and the second predetermined threshold are different from each other.

8. An inverter adapted for outputting phase currents to an electric motor coupled thereto, wherein the inverter comprises several power switches and a control device, wherein the power switches of the inverter are controllable by the control device such that output signals are output to the electric motor for establishing phase currents therein, and wherein the control device is configured to:
control the power switches of the inverter according to a standard inverter control strategy based on a torque request signal received by the inverter such that an output power of the inverter being determined by output signals of the inverter generally corresponds to the torque request signal,
determine a thermal stress factor of the inverter based on a comparison between the unfiltered torque request signal and a filtered torque request signal, wherein the filtered torque request signal comprises trailing edges having a reduced slew rate compared to trailing edges of the unfiltered torque request signal,
change to an adapted inverter control strategy if the thermal stress factor exceeds a first predetermined threshold, wherein, according to the adapted inverter control strategy, the inverter is controlled to generate waste heat after the torque request signal has dropped, and
change back to the standard inverter control strategy if the thermal stress factor falls below a second predetermined threshold.

9. The inverter of claim 8, wherein the control device comprises a fast rise/slow trail filter configured to be applied to the torque request signal for achieving the filtered torque request signal.

10. The inverter of claim 8, wherein the control device is configured to control the power switches of the inverter according to the unfiltered torque request signal when applying the standard inverter control strategy.

11. The inverter of claim 8, wherein the control device is configured to adjust a commutation angle between the d/q output currents output by the inverter to be non-orthogonal.

12. The inverter of claim 8, wherein the first predetermined threshold and the second predetermined threshold are different from each other.

13. A drive unit comprising an inverter according to claim 8, and an electric motor coupled to outputs of the inverter for receiving output signals of the inverter.

14. The method of claim 2, wherein the standard inverter control strategy is such that electric losses are minimized upon operating the inverter.

15. The method of claim 2, wherein for the adapted inverter control strategy a commutation angle between the d/q output currents output by the inverter is adjusted to be non-orthogonal.

16. The method of claim 2, wherein the thermal stress factor of the inverter exceeds the first predetermined threshold if for a predetermined first number of torque request signals within a predetermined first time period, electric losses according to unfiltered torque request signal trailing edge undercut losses according to filtered torque request signal trailing edges by a predetermined first difference threshold.

17. The method of claim 2, wherein the first predetermined threshold and the second predetermined threshold are different from each other.

18. The inverter of claim 9, wherein the control device is configured to control the power switches of the inverter according to the unfiltered torque request signal when applying the standard inverter control strategy.

19. The inverter of claim 9, wherein the control device is configured to adjust a commutation angle between the d/q output currents output by the inverter to be non-orthogonal.

20. The inverter of claim 9, wherein the first predetermined threshold and the second predetermined threshold are different from each other.
